(19) United States
(12) Patent Application Publication
(10) Pub. No.: US 2018/0280786 A1
(43) Pub. Date: Oct. 4, 2018

(54) Skateboard for Maintaining Cruising Speed

(71) Applicant: DGL Group USA, Edison, NJ (US)

(72) Inventors: Joseph Wahba, Brooklyn, NY (US); Michael Wahba, Brooklyn, NY (US)

(21) Appl. No.: 15/603,678

(22) Filed: May 24, 2017

Related U.S. Application Data
(60) Provisional application No. 62/480,120, filed on Mar. 31, 2017.

(51) Int. Cl. A63C 17/12; B60K 7/00; A63C 17/01; B60L 15/00

(52) U.S. Cl. CPC A63C 17/12; B60L 15/00; A63C 17/01; B60K 7/0007

(57) ABSTRACT

An electric skateboard includes a motor, a controller, and a pressure sensor located in a footboard. When a user of the skateboard places a foot on the pressure sensor, the controller measures an actual or estimated speed of the skateboard, and outputs a control signal to the motor to maintain the measured speed. When a user removes his foot from the pressure sensor, the controller sends a control signal to stop the motor.

This application claims priority to U.S. Provisional Application No. 62/480,120, filed Mar. 31, 2017.

### FIELD OF INVENTION

The present disclosure relates to skateboards. More specifically, the present disclosure relates to electric skateboards that can maintain a speed manually set by a user of the skateboard.

### BACKGROUND

Electric skateboards are powered by one or more electric motors, which are typically controlled with a hand-held device. The output of the electric motors drives one or more wheels of the skateboard, causing the skateboard to move with the user. A user can manipulate the hand-held device to increase or decrease the output of the electric motors. The problem with this mode of control is that it results in unnatural and jerky acceleration and deceleration, which can cause a user to lose his or her balance and fall off the skateboard.

Thus, a need exists for an electric skateboard that is powered by an electric motor to move with a user, but does not rely on acceleration or deceleration methods that cause the skateboard to unnaturally jerk the board beneath a user's feet.

### SUMMARY

In an embodiment of the present disclosure, an electric skateboard includes a motor, a controller, and a pressure sensor located in a footboard. When a user of the skateboard places a foot on the pressure sensor, the controller measures an actual or estimated speed of the skateboard, and outputs a control signal to the motor to maintain the measured speed. When a user removes his foot from the pressure sensor, the controller sends a control signal to stop the motor.

### BRIEF DESCRIPTION OF THE DRAWINGS

In the accompanying drawing, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is an exploded view of a skateboard according to an embodiment of the present disclosure; and

FIG. 2 is a flow chart of a method for using the skateboard disclosed in the embodiment of FIG. 1.

### DETAILED DESCRIPTION

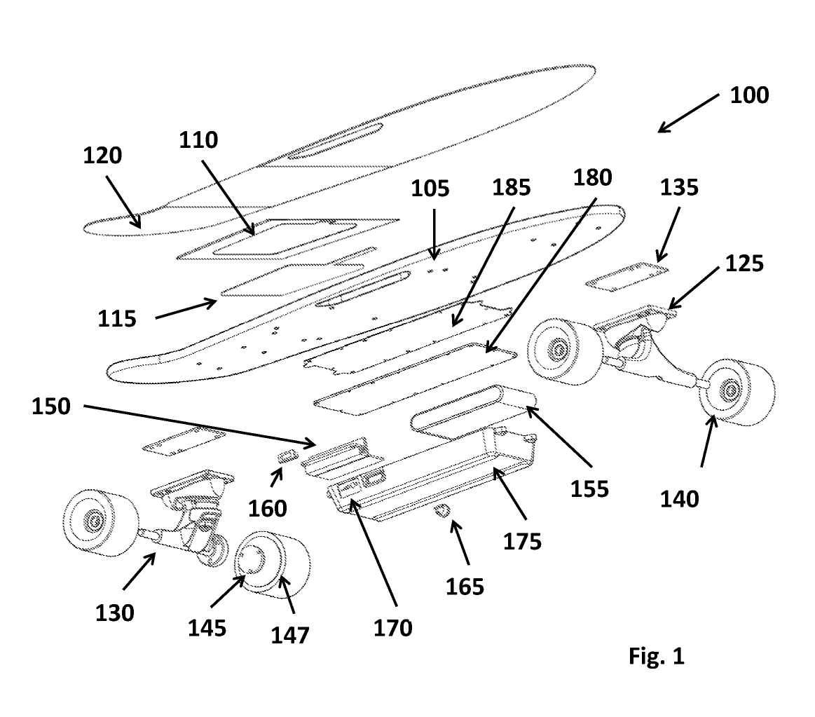

FIG. 1 shows an exploded view of an electric skateboard 100. Skateboard 100 includes a footboard 105 that includes one pressure sensor 110. The footboard 105 is made from a robust, sturdy material such as wood, metal, or a composite, such that it can support a user's weight. The pressure sensor 110 is located on a surface of the footboard 105, on a rear portion of the footboard 105. In alternative embodiments (not shown), the pressure sensor 110 can be placed on other locations on the footboard 105, such as a front region of the board. The pressure sensor 110 is configured to detect when a user's foot is placed on and removed from the pressure sensor 110. In alternative embodiments (not shown), multiple pressure sensors can be used on a surface of the footboard instead of a single pressure sensor.

The pressure sensor 110 is surrounded by a silicone pad 115, which protects the edges of the pressure sensor 110, and provides a softer surface for a user's foot. An abrasive paster 120 overlays the top of the footboard 105, and covers the silicone pad 115 and pressure sensor 110. The abrasive paster 120 protects the silicone pad 115 and pressure sensor 110, and further provides traction for a user standing on footboard 105.

Footboard 105 is fixed to fore trestle 125 and rear trestle 130 with mechanical fasteners, such as screws. Between the footboard 105 and trestles 125, 130, rubber mats 135 are included to absorb forces from bumps and imperfections on a surface on which the skateboard 100 is used.

The fore trestle 125 includes two wheels 140, which are connected to the fore trestle such that wheels 140 are permitted to rotate about a horizontal axis located lateral to a direction of travel of the skateboard 100. Rear trestle 130 includes a wheel 140 and one motor 145 housed within a drive wheel 147. The motor 145 outputs a torque that drives the skateboard 100. The motor 145 can output a range of torques that correspond to different speeds of the skateboard 100. The motor 145 is connected to battery 155 to receive a current. In alternative embodiments (not shown), the skateboard may include two or more drive wheels containing motors, which receive current from a battery.

The skateboard 100 further includes a controller 150, a switch 160, a charging port 165, and a pilot light 170. The controller 150 and battery 155 are enclosed within a protective shell 175, while the switch 160, charging port 165 and pilot light 170 are located on a surface of the protective shell 175. A protective cover 180 attaches to the top of protective shell 175, enclosing the controller 150 and battery 155.

Controller 150 is connected to the pressure sensor 110 via wiring, and can detect when the pressure sensor 110 is depressed by the weight of a user's foot. Controller 150 is further connected to the motor 145, and is configured to receive an input from motor 145 corresponding to an angular velocity of the motor 145. In other embodiments (not shown), the controller 150 can obtain an angular velocity from a wheel 140, using an appropriate sensing element. The controller 150 can also control a torque output of the motor 145. Controller 150 is also connected to the battery 155 to receive power.

The protective shell 175 and protective cover 180 prevent either physical or elemental damage to the controller 150 and battery 155. Protective shell 175 is mounted to footboard 105 with mechanical fasteners, such as screws. A bubble cotton mat 185 is located between protective cover 180 and footboard 105. Bubble cotton mat 185 absorbs impact forces while the skateboard 100 is in motion, and dampens the forces transferred to protective shell 175. In alternative embodiments (not shown), other shock-absorbing members may be used instead of bubble cotton mat, such as fabrics or polymers. In other alternative embodiments (not shown), the bubble cotton mat can be omitted.

Charging port 165 is designed to receive a plug from a charging adaptor (not shown) to recharge the battery 155. The pilot light 170 is connected to the battery 155, and indicates the level of charge of the battery 155. The pilot light 170 could, for example, include yellow, red, and green lights that indicate the level of charge. Switch 160 selectively turns the controller 150, pilot light 170, and motor 145 on and off.

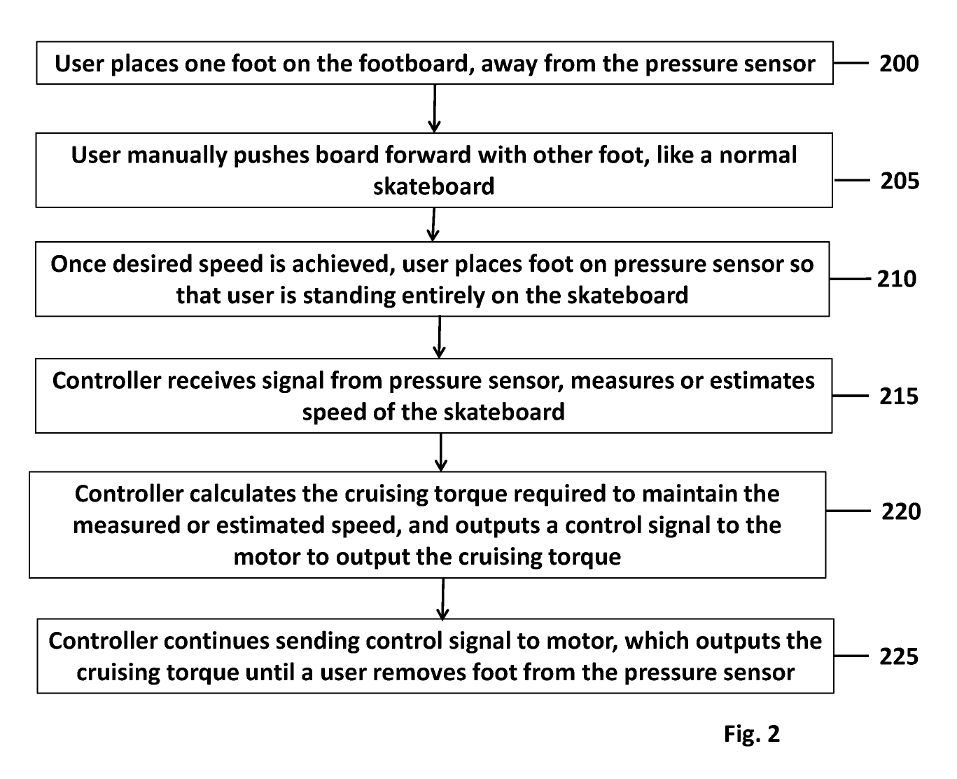

With reference to the flow chart in FIG. 2, a method for operating the skateboard 100 will now be described. In step 200, a user of the skateboard first places one foot on the footboard 105, but not on the portion of the footboard 105 where the pressure sensor 110 is located. The user's other foot remains on the ground. In step 205, the user then manually pushes the skateboard 100 forward using the foot that is on the ground in the same fashion that a user would operate a normal skateboard. In step 210, the user may push the skateboard 100 to whatever speed he desires, and once the skateboard 100 is moving at a desired speed, the user places his other foot on the pressure sensor 110, so that the user is now standing on the footboard 105 with both feet.

At step 215, the controller 150 detects when a user's foot is placed on the pressure sensor 110, and then reads the current angular velocity of motor 145. In step 220, the controller 150 calculates a torque output that corresponds to the measured angular velocity of the motor 145, referred to as a “cruising torque,” and sends a control signal to the motor 145 that causes the motor 145 to output the cruising torque. In step 225, the controller 150 maintains this control signal until the user removes his foot from the pressure sensor 110, at which time the controller 150 sends a control signal to the motor 145 to cease the output of the cruising torque. In alternative embodiments, the controller 150 could simply cease sending the control signal to the motor 145 when the user removes his foot from the pressure sensor 110.

There are alternative methods of controlling the skateboard 100, and different elements may be used to control the skateboard 100. For example, instead of detecting an angular velocity of the motor 145 or wheel 140, the controller 150 could measure the velocity of the skateboard 100 by using a position sensor mounted to the footboard 105 or either trestle 125, 130. In other alternative embodiments, the controller 150 could output a control signal for a cruising torque that corresponds to an angular velocity slightly less than the measured angular velocity from the motor 145.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative system and method, and illustrative examples shown and described. Accordingly, departures may be made from such details without departing from the spirit or scope of the applicant's general inventive concept.

1. An electric skateboard, comprising:
a footboard;
a plurality of wheels connected to the footboard and configured to rotate relative to the footboard,
wherein the wheels rotate about an axis of rotation that is perpendicular to
a longitudinal axis of the footboard;
a controller mounted to the footboard;
a motor mounted to the footboard and in signal communication with the controller; and
a pressure sensor mounted to the footboard and in signal communication with the controller,
wherein the pressure sensor is configured to send a pressure signal to the controller upon detecting a foot placed on the pressure sensor,
wherein the controller is configured to measure an angular velocity of the motor upon receiving the pressure signal from the pressure sensor,
wherein the controller is configured to output a control signal to the motor upon receiving the pressure signal, and
wherein the control signal causes the motor to output a torque sufficient to maintain the measured angular velocity.

2. The electric skateboard of claim 1, wherein the motor is contained within a wheel.

3. (canceled)

4. (canceled)

5. The electric skateboard of claim 1, wherein the control signal causes the motor to output a cruising torque.

6. (canceled)

7. The electric skateboard of claim 1, wherein the controller does not output the control signal when the pressure signal is not present.

8. The electric skateboard of claim 1, wherein the plurality of wheels comprises at least 4 wheels.

9. A method for operating an electric skateboard comprising the steps of:
manually moving the electric skateboard forward without engaging an electric motor;
engaging a pressure sensor on the electric skateboard to output a pressure signal to a controller on the electric skateboard,
wherein the controller measures a current speed of the skateboard upon receipt of the pressure signal, generates a control signal corresponding to the measured speed of the skateboard, and outputs the control signal to a motor,
wherein the motor outputs a torque sufficient to maintain the measured speed of the skateboard upon receipt of the control signal; and
disengaging the pressure sensor on the electric skateboard,
wherein the pressure sensor ceases outputting the pressure signal upon disengagement,
wherein the controller to ceases outputting the control signal upon cessation of the pressure signal, and
wherein the motor ceases outputting the torque upon cessation of the control signal.

10. The method for operating the electric skateboard of claim 9, wherein the controller measures the current speed of the skateboard using a position sensor.

11. The method for operating the electric skateboard of claim 9, further comprising a sensor used to detect an angular velocity of a wheel of the electric skateboard.

12. The method for operating the electric skateboard of claim 9, wherein the controller continues to output the control signal for as long as the pressure sensor is engaged.

13. A skateboard comprising:
a footboard;
a plurality of wheels connected to the footboard and configured to rotate relative to the footboard;
a controller mounted to the footboard,
wherein the controller is configured to detect a speed of the skateboard;
a motor mounted to the footboard and in signal communication with the controller;
a battery connected to the controller and to the motor, to provide electrical current to both the controller and the motor; and
a pressure sensor mounted to the footboard and configured to send a pressure signal to the controller upon detecting a foot placed on the pressure sensor,
wherein the controller outputs a control signal to the motor corresponding to the speed signal, after receiving the pressure signal, and
wherein the control signal causes the motor to output a torque sufficient to maintain a speed that is less than the detected speed of the skateboard.

14. The skateboard of claim 13, further including a position sensor mounted to the skateboard, and wherein the controller detects the speed of the skateboard by receiving a signal from a position sensor mounted to the skateboard.

15. The skateboard of claim 13, wherein the controller detects the speed of the skateboard by measuring an angular velocity of a wheel at the time the controller receives the pressure signal.

16. The skateboard of claim 15, wherein the control signal corresponds to the measured angular velocity of the wheel at the time the controller receives the pressure signal.

17. The skateboard of claim 15, wherein the control signal corresponds to a cruising angular velocity that is less than the measured angular velocity of the wheel at the time the controller receives the pressure signal.

18. The skateboard of claim 13, wherein the control signal causes the motor to output the torque for as long as the control signal is generated.

19. The skateboard of claim 13, wherein the pressure sensor is located on a top surface of the footboard.

20. The skateboard of claim 19, further including an abrasive paster located on a top surface of the pressure sensor.

21. The skateboard of claim 13, wherein the motor is housed inside one of the plurality of wheels.
